(19) United States
(12) Patent Application Publication
(10) Pub. No.: US 2024/0396046 A1
(43) Pub. Date: Nov. 28, 2024

(54) LITHIUM-ION BATTERY COMPONENT WITH CROSSLINKED BINDER

(71) Applicant: FORD GLOBAL TECHNOLOGIES, LLC, Dearborn, MI (US)

(72) Inventors: Insik Jeon, Novi, MI (US); Michael Lerner, Coravallis, OR (US); Wei Xu, Westland, MI (US); Feng Li, Troy, MI (US); Jonghwan Park, Ann Arbor, MI (US)

(21) Appl. No.: 18/324,209

(22) Filed: May 26, 2023

(51) Int. Cl. H01M 4/62; H01M 4/133; H01M 4/134; H01M 4/38; H01M 4/587; H01M 10/0525

(52) U.S. Cl. CPC H01M 4/622; H01M 4/133; H01M 4/134; H01M 4/386; H01M 4/587; H01M 10/0525

(57) ABSTRACT

A lithium-ion battery component and pre-cured electrode are disclosed, featuring a current collector and a slurry containing graphite, silicon-based particles, and a chemically cross-linkable monomer. Upon initiation, the monomer chemically crosslinks to form a binder that mechanically binds the graphite and silicon-based particles, creating a coating adhered to the current collector the chemically crosslinked binder enables volume expansion during charging and facilitates volume contraction during discharging, maintaining some of the electrode's initial capacity. The chemically cross-linkable monomer is present at a weight percentage relative to the graphite and silicon-based particles, while the current collector is composed of a metal foil. The battery component and pre-cured electrode may increase performance and longevity in lithium-ion batteries through their chemically crosslinked binder and slurry composition.

### TECHNICAL FIELD

The disclosure relates to electrode materials for lithium-ion batteries.

### BACKGROUND

Anodes containing electrochemically active silicon particles have been investigated due to their significantly high theoretical capacity. Silicon-based anodes are susceptible to volume expansion and contraction. To mitigate the issues associated with volume changes in silicon-based anodes, various approaches have been explored, including the use of binders that can accommodate the volume expansion and contraction of anode materials. Binders help maintain structural integrity by promoting good adhesion and cohesion in the electrode. Traditional binders, such as polyvinylidene fluoride (PVDF) may not be able to effectively accommodate the volume changes associated with silicon-based particles, leading to performance issues.

### SUMMARY

In one example, a lithium-ion battery component comprises a pre-cured electrode, which includes a current collector and a slurry applied thereon. The slurry includes graphite, silicon-based particles, and a chemically cross-linkable monomer. The chemically cross-linkable monomer is configured to, responsive to initiation, chemically crosslink and form a chemically crosslinked binder that mechanically binds the graphite and silicon-based particles together, resulting in the formation of a coating adhered to the current collector. The chemically crosslinked binder is also configured to permit volume expansion of the coating during charge of the electrode and facilitate volume contraction of the coating during discharge.

In another example, a pre-cured electrode comprises a current collector and a slurry on the current collector. The slurry includes an active material and chemically cross-linkable monomer. The chemically cross-linkable monomer is configured to, upon initiation, chemically crosslink to form a chemically crosslinked binder that cohesively binds the active materials and other electrode components together, forming a coating adhered to the current collector. The chemically crosslinked binder also decreases mechanical degradation during the volume expansion of the coating during charge of the electrode and facilitate volume contraction of the coating during discharge.

In a further example, a pre-cured electrode comprises a current collector and a slurry on the current collector. The slurry includes graphite, silicon-based particles, and a chemically cross-linkable monomer having at least two functional groups. The chemically cross-linkable monomer is configured to, responsive to curing of the slurry, chemically crosslink to form a chemically crosslinked binder that mechanically binds the graphite and silicon-based particles together, resulting in the formation of an electrode with a coating adhered to the current collector. The chemically crosslinked binder is also configured to facilitate contraction of the coating during discharge of the electrode.

### BRIEF DESCRIPTION OF THE DRAWINGS

FIG. 1 is a cross-sectional view illustrating an electrode with a chemically crosslinked binder;

FIG. 2 is a flowchart of a cross-sectional view of an electrode without a chemically crosslinked binder battery charging and discharging; and

FIG. 3 is a flowchart of a cross-sectional view of an electrode with a chemically crosslinked binder charging and discharging.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Graphite anodes blended with silicon X (Si, SiOx, Si/C) may offer higher anode energy densities compared with graphite-only anodes. High volume expansion of silicon, nearly 300%, is accompanied while cycling, leading to potential capacity fade via silicon particle pulverization and solid-electrolyte interface destabilization, volume change during full-depth cycling, and loss of electric contact between active materials and current collectors.

Styrene-butadiene rubber is an anode binder, commonly used for graphite or silicon X-graphite anodes. This rubbery binder may not effectively suppress anode swelling when the silicon X ratio is higher than 10%. Its lack of elasticity may make it difficult to prevent anode issues associated with high electrode swelling (e.g., volume expansion by charging/lithiation).

Electrodes for use in battery cells are manufactured through a process that involves coating a current collector with a slurry containing an active material, such as graphite or silicon, and a binder material. The pre-cured electrode is then cured to produce a solid electrode. The curing process consists of drying the pre-cured electrode. This can be done by heating the pre-cured electrode to a specific temperature to harden the slurry and form a durable electrode.

The present disclosure in one aspect relates to the inclusion of a chemically cross-linkable monomer in lithium-ion battery components, including pre-cured electrodes. The chemically cross-linkable monomer forms a chemically crosslinked binder in the electrode, which enables volume expansion and contraction during charge and discharge cycles, resulting in increased performance. The chemically crosslinked binder mechanically binds electrode materials together while permitting volume changes, resulting in increased capacity and dimensional retention. In some embodiments, the chemically cross-linkable monomer may be present in an amount of 1-20 wt % relative to the graphite and silicon-based particles. In other embodiments, the chemically cross-linkable monomer may be present in an amount of 1-10 wt % relative to the graphite and silicon-based particles.

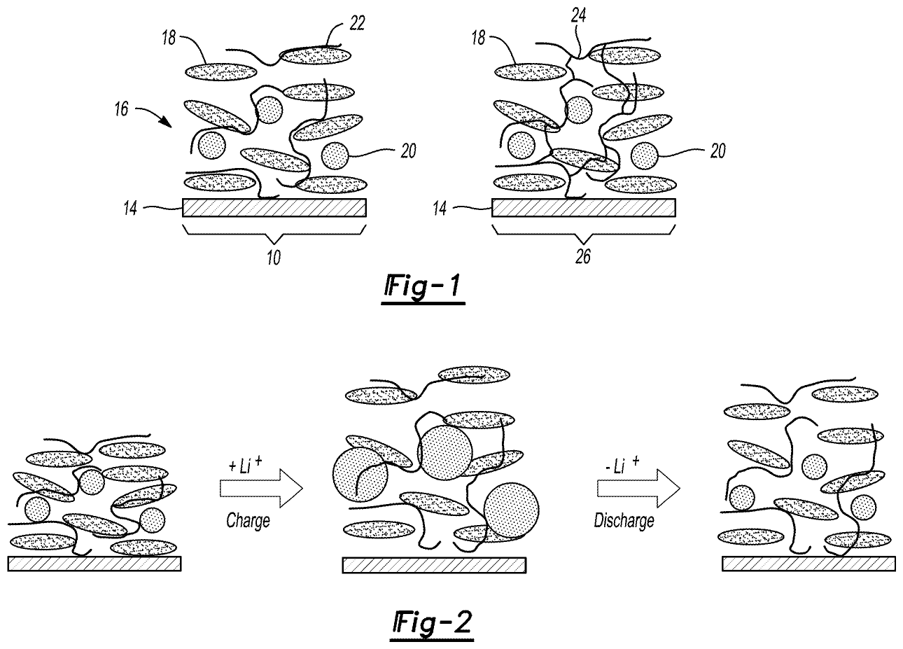

Referring now to FIG. 1, in the first view 10 the pre-cured electrode 12 comprises a current collector 14 and a slurry 16 applied thereon. It can be appreciated by those familiar in the art that a green anode represents an unmanufactured anode, which has not yet undergone the necessary processes to achieve its full potential in terms of functionality, durability, and electrochemical performance. The current collector 14 may be a metal foil, such as, but not limited to, copper, aluminum, or other suitable materials. The current collector 14 provides electrical conductivity and a surface for adhesion of the slurry 14. The slurry 14 comprises graphite particles 18, silicon-based particles, 20, chemically cross-linkable monomer 22, and a binder material. The graphite particles 18 serve as an active material for lithium-ion storage and provide good electronic conductivity. The silicon-based particles 20 also serve as an active material and offer a higher theoretical capacity compared to graphite particles 18. The chemically cross-linkable monomer 22 is configured to, responsive to initiation, chemically crosslink to form a chemically crosslinked binder 24. The binder material can be styrene butadiene rubber (SBR) or any other known material suitable for the purpose. The initiator triggers the polymerization reaction amongst the cross-linkable monomer 22 and binder leading to the formation of the chemically crosslinked binder 24. The initiator can be benzoyl peroxide (BPO), azobisisobutyronitrile (AIBN), or other suitable material.

In the second view 26 upon initiation, the chemically cross-linkable monomer 22 reacts to form the chemically crosslinked binder 24, which mechanically binds the graphite particles 18 and the silicon-based particles 20 together. The formation of the chemically crosslinked binder 24 results in the creation of a coating adhered to the current collector 14. The chemically crosslinked binder 24 is configured to permit volume expansion of the coating during the charging process of the electrode 28 and facilitate volume contraction of the coating during the discharging process of the electrode 28. FIG. 1 illustrates that the chemically crosslinked binder 24 forms a network structure that surrounds and interconnects the graphite particles 18 and the silicon-based particles 20, providing mechanical stability and facilitating the adhesion of the slurry 16 to the current collector 14. The chemically crosslinked binder 20, due to its interconnecting network structure, is also capable of accommodating the volume changes experienced by the silicon-based particles 20 during charge and discharge cycles, thereby maintaining the structural integrity and performance of the electrode. The increased mechanical stability provided by the interconnecting network structure of the chemically crosslinked binder 24 also results in better retention of initial capacity during charge and discharge cycles, with a retention rate of 80%. In the context of an electrode, capacity refers to the amount of electrical charge that can be stored and released by the electrode during a charge and discharge cycle.

The weight percentage of the chemically crosslinked monomer 22 relative to the combined weight of the graphite particles 18 and silicon-based particles 20 may be within a range of 1-20 wt % or, more specifically, within a range of 1-10 wt %. An increase in the weight percentage of the cross-linkable monomer results in a higher degree of chemical crosslinking, leading to a more tightly interconnected network structure and further increase mechanical properties. The weight percentages of the cross-linkable monomer and active material disclosed herein have been determined to provide a desired balance between the wt % of cross-linkable monomer required to achieve optimal mechanical stability and adhesion of the electrode, and the wt % of active material needed to achieve desirable electrochemical performance. It should be noted that these weight percentages have been shown to work well without reducing the capacity or other aspects of the electrode. The specific weight percentage can be adjusted based on the desired properties and performance requirements of the lithium-ion battery.

Referring now to FIG. 2, in the first view, graphite particles, silicon-based particles, and a binder that is not chemically crosslinked are shown under nominal conditions. The binder is present in its non-crosslinked state, providing limited mechanical stability and adhesion between the particles and the current collector. In the second view, the anode gains lithium ions and charges. causing volume expansion of the silicon-based particles. Due to the absence of a chemically crosslinked network, the binder is not able to accommodate the volume changes in the silicon-based particles, resulting in weakened structural integrity and reduced adhesion between the particles and the current collect. In the third view, the electrode has been discharged, and lithium ions have been removed from the silicon-based particles. The volume of the silicon-based particles has contracted, leading to further wear and deterioration of the volumetric stability of the slurry. Over time, this can influence the battery's performance and capacity retention.

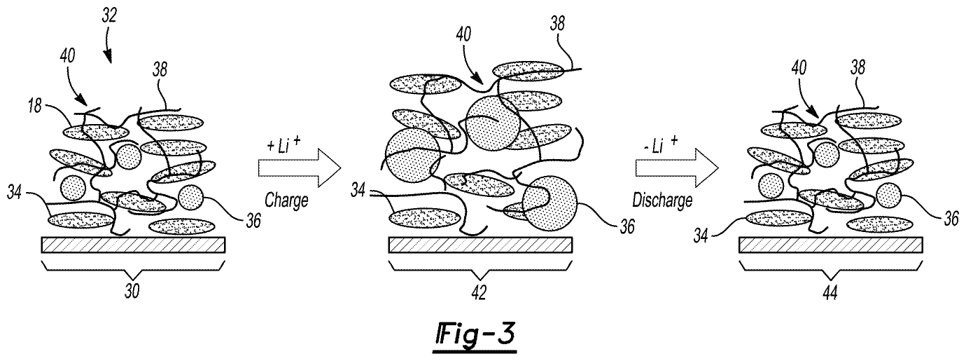

Referring now to FIG. 3, in the first view 30, the anode 32 comprises graphite particles 34, silicon-based particles 36, and a chemically crosslinked binder 38 that forms a network structure 40 surrounding and interconnecting the particles, providing the mechanical stability and adhesion between the particles and the current collector. In the second view 42, the anode gains lithium ions and charges, causing volume expansion of the silicon-based particles 36. The chemically crosslinked binder 38 effectively accommodates the volume changes in the silicon-based particles 36 due to its crosslinked network structure 40, maintaining the structural integrity of the electrode and the adhesion between the particles and the current collector. In the third view 44, the anode 32 has been discharged, and lithium ions have been removed from the silicon-based particles 36. The volume of the silicon-based particles 36 has contracted, but the volumetric stability of the anode has been largely maintained, due to the chemically crosslinked binder 38. This increased volumetric stability helps to maintain the performance and capacity retention of the lithium-ion battery over numbers charge and discharge cycles. The increased volumetric stability provided by the interconnecting network structure 40 of the chemically crosslinked binder 38 also results in 80% retention of initial capacity during charge and discharge cycles.

This disclosure thus contemplates methods to construct graphite/silicon X anodes containing elastomeric crosslinked binders to suppress electrode swelling and promote recovery from volume expansion while lithium discharging. The crosslinking monomers crosslink with an anode binder, styrene butadiene rubber for example, to form an elastomeric binder system. The gained elastomeric force increases graphite/silicon X anode dimension stability, thus allowing for longer cell cycle life.

Use of cross-linkable monomers may result in less calendaring by acting as plasticizers before curing, and mitigate anode spring back after vacuum drying. Cross-linkable monomers and styrene butadiene rubber in the graphite/silicon X anode proceed thermal curing to elastomers in the presence of radical initiators such as benzoyl peroxide.

Graphite/silicon X anodes may contain artificial or synthetic graphite, silicon (Si, SiOx, Si/C), cross-linkable monomers, radical initiators, conducting materials, styrene-butadiene rubber, and carboxymethyl cellulose. Cross-linkable monomers react with vinyl groups and/or benzylic radicals of styrene-butadiene rubber to create elastic binder system.

Cross-linkable monomers include but are not limited to multi-functional acrylics such as pentaerythritol tetra-acrylate, ethoxylated pentaerythritol tetra-acrylate, ditrimethylolpropane tetra-acrylate, dipentaerythritol penta-acrylate, dipentaerythritol hexa-acrylate, or ethoxylated dipentaerythritol hexa-acrylate as single or a form of blending thereof. Curing proceeds in the presence of radical initiators via thermo-, UV-, or E-beam. Curing initiators include but are not limited to peroxides, phosphorus compounds, or sulfates.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A lithium-ion battery component comprising:
a pre-cured electrode including a current collector and a slurry thereon including graphite, silicon-based particles, and a chemically cross-linkable monomer configured to, responsive to initiation, chemically crosslink to form a chemically crosslinked binder (i) mechanically binding the graphite and silicon-based particles together resulting in formation of a coating adhered to the current collector and (ii) configured to permit volume expansion of the coating during charge of the electrode and facilitate volume contraction of the coating during discharge.

2. The lithium-ion battery component of claim 1, wherein the chemically crosslinked binder is configured to permit volume expansion of the coating during charge of the electrode and facilitate volume contraction of the coating during discharge of the electrode such that the electrode maintains 80% of initial capacity.

3. The lithium-ion battery component of claim 1, wherein the chemically cross-linkable monomer is 1-20 wt % relative to the graphite and silicon-based particles.

4. The lithium-ion battery component of claim 3, wherein the chemically cross-linkable monomer is 1-10 wt % relative to the graphite and silicon-based particles.

5. The lithium-ion battery component of claim 1, wherein the current collector is a metal foil.

6. A pre-cured electrode comprising:
a current collector; and
a slurry on the current collector and including an active material, and a chemically cross-linkable monomer configured to, upon initiation, chemically crosslink to form a chemically crosslinked binder that (i) cohesively binds the active material together, forming a coating adhered to the current collector, (ii) enables volume expansion of the coating during charge of the electrode, and (iii) facilitates volume contraction of the coating during discharge.

7. The pre-cured electrode of claim 6, wherein the chemically crosslinked binder is configured to permit volume expansion of the coating during charge of the electrode and facilitate volume contraction of the coating during discharge of the electrode such that the electrode maintains 80% of initial capacity.

8. The pre-cured electrode of claim 6, wherein the chemically cross-linkable monomer is 1-20 wt % relative to the active material.

9. The pre-cured electrode of claim 8, wherein the chemically cross-linkable monomer is 1-10 wt % relative to the active material.

10. The pre-cured electrode of claim 6, wherein the current collector is a metal foil.

11. A pre-cured electrode comprising:
a current collector; and
a slurry on the current collector and including graphite, silicon-based particles, and a chemically cross-linkable monomer having at least two functional groups configured to, responsive to curing of the slurry, chemically crosslink to form a chemically crosslinked binder mechanically binding the graphite and silicon-based particles together resulting in formation of an electrode with a coating (i) adhered to the current collector and (ii) configured to facilitate contraction of the coating during discharge of the electrode.

12. The pre-cured electrode component of claim 11, wherein the chemically crosslinked binder is configured to configured to permit volume expansion of the coating during charge of the electrode and facilitate volume contraction of the coating during discharge of the electrode such that the electrode maintains 80% of initial capacity.

13. The pre-cured electrode component of claim 11, wherein the chemically cross-linkable monomer is 1-20 wt % relative to the graphite and silicon-based particles.

14. The pre-cured electrode component of claim 13, wherein the chemically cross-linkable monomer is 1-10 wt % relative to the graphite and silicon-based particles.

15. The pre-cured electrode battery component of claim 11, wherein the current collector is a metal foil.
